(19) United States
(12) Patent Application Publication
(10) Pub. No.: US 2007/0084138 A1
(43) Pub. Date: Apr. 19, 2007

(54) Sliding storm shutters

(76) Inventors: Larry J. Cassista, Auburndale, FL (US); Andrew N. Cassista, Auburndale, FL (US); Daniel A. Cassista, Auburndale, FL (US)

Correspondence Address: JAMES RAY & ASSOCIATES, 2640 PITCAIRN ROAD, MONROEVILLE, PA, 15146, US

(21) Appl. No.: 11/580,450

(22) Filed: Oct. 14, 2006

Related U.S. Application Data
(60) Provisional application No. 60/728,091, filed on Oct. 19, 2005.

(51) Int. Cl. E06B 3/26

(52) U.S. Cl. 52/202

(57) ABSTRACT

Exterior windows on a structure are protected from storm damage by solid panels in pairs mounted in frame members of an attachment apparatus positioned above and below the window and on the exterior of a structure. U-shaped channels are disposed above and below the window and are of sufficient. width to hold the pair of solid panels either closely adjacent vertical edges of the window or in front of the window. The attachment mechanism is adapted so as to securely hold the panels while still permitting that the shutters can be slid sideways until touching each other to protect the window during severe storms such as hurricanes. During normal weather, the shutters can either be left adjacent the outer edges on the window frames, or removed to storage if desired. The shutters are designed to be attractive as well as protective. Methods of securing the panels. in the desired position and attaching the channels are provided.

### CROSS REFERENCE TO RELATED APPLICATIONS

This application is closely related to and claims benefit from U.S. Provisional Application Ser. No. 60/728,091 filed Oct. 19, 2005.

### FIELD OF THE INVENTION

The present invention relates generally to shutters for protecting windows on a structure during a storm such as a hurricane, and more particularly, to storm panels that are sufficiently attractive to normally be left adjacent to the vertical edges of the window exterior.

### BACKGROUND OF THE INVENTION

Typical glass windows are not strong enough to withstand the strong winds and flying debris that are present in a hurricane or tropical storm. Accordingly, a multitude of devices have been devised to put into place as the storm approaches. Many of these are temporary panels that are nailed, screwed, or bolted to the structure to cover the window. Others are permanently attached to the structure, and then put into place over the window at the appropriate time, such as roll-down shields and awnings that fold down. These are typically unattractive, and often are stored away during the non-hurricane season.

Over the years, a number of innovations have been made known for the protection of glass windows during severe storms. For example, U.S. Pat. No. 5,603,190 depicts a system with a pair of tracks permanently installed with a made-to-fit single panel that slides in when the storm approaches, but is stored in a garage or somewhere else most of the time. U.S. Pat. No. 3,528,196 discloses multiple removable panels that can be inserted and then overlap from the top down. U.S. Pat. No. 4,685,261 discloses tough, removable translucent panels that mount into tracks above and below the window. A single panel is brought from storage and snapped into the tracks when the need arises. The panels come with a border.

U.S. Pat. No. 5,228,238 teaches a rather involved design for a transparent storm shutter that can be rolled up or down, but is also hinged at the top so it can be propped open at the bottom somewhat.

U.S. Pat. No. 4,384,436 discloses a combination security grill and hurricane shutter. The framework of metal bars provides an attractive appearance, but conversion to a shutter entails screwing or bolting a panel such as plywood that must to stored somewhere then brought out and installed, perhaps under adverse conditions with some degree of difficulty, and taking a significant amount of time.

U.S. Pat. No. 4,333,271 discloses a hurricane panel made of corrugated sheet metal that is installed in top and bottom tracks, and which can be locked from inside the building. Once again, the panel must be stored remotely, then located and installed when needed.

One characteristic of all these prior designs is the lack of any regard for the appearance of the panels, and in nearly all cases they are not part of the structure's decor. In addition, most require a remote storage location. Hence, it would be desirable to have storm panels that are both attractive and functional, and consequently eliminate the need to store them somewhere and then hunt for and install them when needed.

### SUMMARY OF THE INVENTION

The present invention offers an improved storm shutter arrangement that is both highly functional and aesthetically pleasing, yet easily put into protective mode. The apparatus for protecting windows on a structure during a severe storm, consists of a pair of solid panels, each having a predetermined shape and a predetermined size and formed of a predetermined material; and an attachment means disposed on the exterior portion of a structure above and below the windows for holding the pair of solid panels either closely adjacent vertical edges of such window or in front of such window, this attachment means including at least two U-shaped channels for securing the pair of solid panels yet permitting the panels to slide sideways. The U-shaped channels extend sufficiently wider than the windows to prevent said pair of solid panels from tipping when they are moved to a position totally uncovering such windows.

### OBJECTS OF THE INVENTION

It is therefore an object of the present invention to provide an improved style of storm protection for windows that does not require remote storage of the shutters and is unlikely to detract from the appearance of the structure.

It is a further object of this invention to provide a quick and easy method of installing hurricane shutters regardless of whether or not they are permanently left on the exterior of the structure.

These and various other objects and advantages of this invention will become apparent after a full reading of the following detailed description, particularly, when read in conjunction with the attached drawings as described below and the appended claims.

### BRIEF DESCRIPTION OF DRAWINGS

The invention will be better understood by referring to the drawings.

FIG. 1 is a frontal view with the shutters closed.

FIG. 2 is a perspective view of a lower channel before installation.

FIG. 3 is an end view of a bottom channel showing the groove, a locking pin, and the installation lip at the upper left. FIG. 4 is a front view of a-window with the shutters in the open position.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

With reference to the aforementioned drawings, the improved apparatus 30, consisting of storm shutters and attachment means, of this invention will be described.

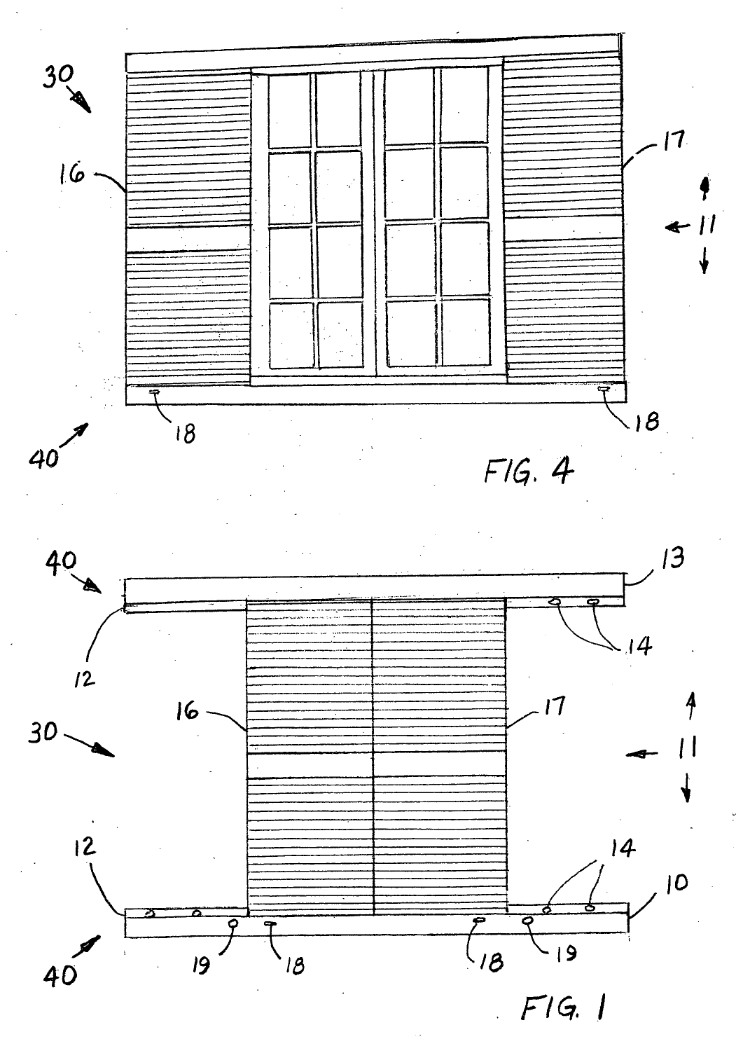

With reference to FIG. 1, the lower channel of the attachment means 40 is attached to the structure 11, with the open portion of the three-sided channel 10 facing upwards, utilizing screws or bolts 14 passing through holes in the lip extension 12 of channel 10. The upper channel 13 is likewise attached above the window with the open side facing downward. The spacing is such that the panels 16 and 17 slide into the tracks of 10 and 13 from either end. Locking pins 18 secure the shutters in the desired location, and padlock holes 19 are shown for optional locking of the panels to prevent opening or removal when in the closed position.

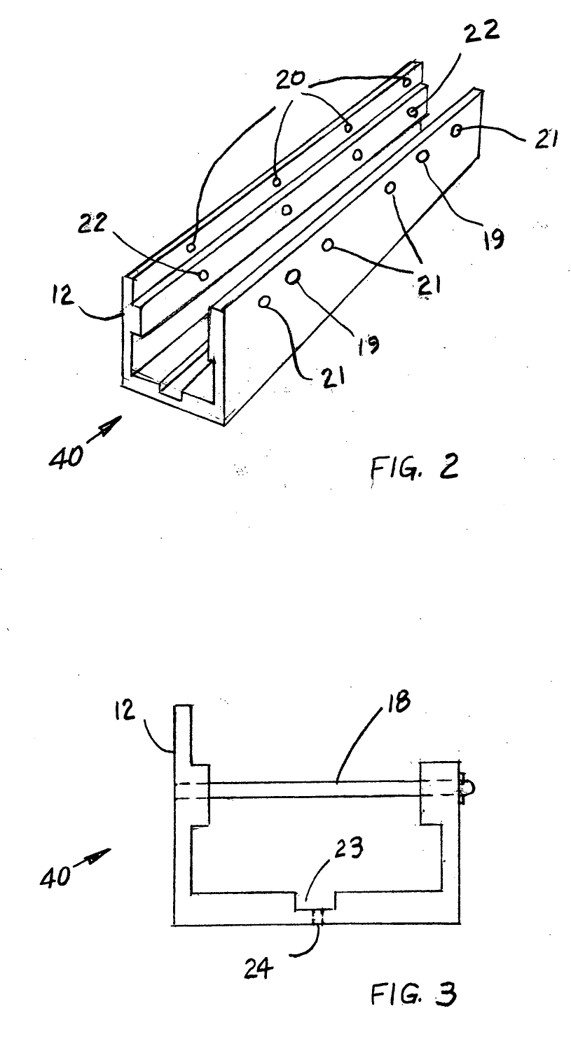

FIG. 2 offers a perspective view of the lower channel showing apertures 20 in the attachment lip 12 and apertures 21 for the locking pins. In addition, slightly countersunk apertures 22 are shown in the back side of the channel opposite the apertures 21.

A further embodiment of the invention is illustrated in FIG. 3, which is an end view of the lower channel 10 showing features such as a longitudinal groove 23, the attachment lip 12, a drain hole 24, and a locking pin 18.

FIG. 4 illustrates the invention with the shutter panels 16 and 17 in the normal, day-to-day, open position and held in place by L-shaped locking pins 18 held by a retaining clip.

The present invention offers an improved storm shutter arrangement that is both highly functional and aesthetically pleasing, yet easily put into protective mode. The apparatus 30 for protecting windows on a structure 11 during a severe storm, consists of a pair of solid panels 16, 17, each having a predetermined shape and a predetermined size and formed of a predetermined material; and an attachment means, generally designated 40, disposed on the exterior portion of a structure above and below the windows for holding the pair of solid panels 16, 17 either closely adjacent vertical edges of such window or in front of such window, this attachment means 40 including at least two U-shaped channels 10, 13 for securing the pair of solid panels 16, 17 yet permitting the panels 16, 17 to slide sideways. The U-shaped channels 10, 13 extend sufficiently wider than the windows to prevent said pair of solid panels 16,17 from tipping when they are moved to a position totally uncovering such windows.

The two or more U-shaped channels 10, 13 with the long open sides facing each other are mounted to the structure above and below the window. Typically, each channel 10, 13 is slightly double the width of the window with nearly equal extension beyond the window width on each side. The channels 10, 13 could be made of aluminum, fiberglass-reinforced plastic, or any suitable plastic or metal. An extended lip 12 along the interior side of the channel 10 provides a means for easy installation to the structure 11. In addition, the channel may be coated or pigmented so as to blend into the exterior of the structure 11. Both the upper and lower channels 10, 13 are similar and have a drain hold 24 disposed therein and could be fabricated with an optional groove. The decorative and protective panels or shutters slide into and along the tracks created by the channels 10, 13. The panels 16, 17 would be typically rectangular-and made of wood, metal or plastic, and coated or pigmented as desired. Various sorts of locking pins 18, screws or bolts 14 can be used to hold them once in the desired position, either adjacent to the vertical edges of the window, or in front of the window. Optionally, padlocks could be installed at the outer top edge of the lower channel to prevent removal or opening of the panels. Depending on the width and height of the windows, reinforcing members would be attached to or embedded in the shutter panels. Also, for oversized windows extra shutters could be installed in the tracks to cover the wider windows. Thus, the present invention can be used for virtually any window arrangement.

In the preferred embodiment of this invention, the shutters would always be in place on the exterior of the structure, and simply slid and secured in the closed position with a locking pin and padlock as a severe storm approaches. However, the panels could be readily removed and installed as needed if the owner feels that they do not fit the décor of the building. The appearance of the panels would be much like the decorative shutters typically found on houses, such as a multitude of overlapping slats or numerous designs that exist today.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. An apparatus for protecting windows on a structure during a severe storm, said system comprising:
(a) a pair of solid panels, each of said pair of solid panels having each of a predetermined shape and a predetermined size and formed of a predetermined material; and
(b) an attachment means disposed on an exterior portion of such structure for holding said pair of solid panels one of being closely adjacent vertical edges of such window and in front of such window, said attachment means including at least two U-shaped channels for slidingly securing said pair of solid panels, one of said at least two U-shaped channels disposed above such window and another one of said at least two U-shaped channels disposed below such window, said at least two U-shaped channels extending at least sufficient to prevent said pair of solid panels from tipping when said pair of solid panels are moved to a position away from such windows.

2. The apparatus, according to claim 1, wherein said predetermined size of said pair of solid panels is sufficient to completely cover such window when said pair of solid panels are abutting each other.

3. The apparatus, according to claim 1, wherein said predetermined shape of said pair of solid panels is substantially rectangular.

4. The apparatus, according to claim 1, wherein said pair of solid panels are slidingly engageable with said at least two U- shaped channels.

5. The apparatus, according to claim 1, wherein such window is completely uncovered when said pair of solid panels are slid away from such window.

6. The apparatus, according to claim 1, wherein said at least two U-shaped channels are formed from one of aluminum and plastic.

7. The apparatus, according to claim 6, wherein said plastic is a reinforced thermosetting plastic.

8. The apparatus, according to claim 1, wherein said predetermined material for said pair of solid panels is selected from one of aluminum, galvanized steel, and plastic.

9. The apparatus, according to claim 8, wherein said plastic is impact resistant.

10. The apparatus, according to claim 1, wherein said channel disposed below such window of such structure further includes drain holes disposed in said channel for preventing water accumulation.

11. The apparatus, according to claim 1, wherein said pair of solid panels are shutters.

12. The apparatus, according to claim 1, wherein said pair of solid panels have at least one reinforcing rod disposed within each solid panel.

13. The apparatus, according to claim 1, wherein said channel disposed below such window of such structure further includes apertures formed therein for removable insertion of a pair of locking pins for holding said pair of panels in a desired location.

14. The apparatus, according to claim 13, wherein said pair of locking pins are L-shaped such that they rotate and engage with clips attached on said channel adjacent to said apertures.

15. The apparatus, according to claim 1, wherein said channel disposed below such window of such structure further includes an extended lip disposed longitudinally along a side of said channel closest to such structure.

16. The apparatus, according to claim 15, wherein said extended lip includes apertures one of formed therein and drilled therein for attachment to such structure.

17. The apparatus, according to claim 15, wherein said channel is attached to such structure by means of one of screws and bolts.

18. The apparatus, according to claim 13, wherein said panels can be one of left in place and removed for storage during periods of normal weather.

19. The apparatus, according to claim 1, wherein said at least two U-shaped channels extend at least twice a width of such window.
